(19) United States
(12) Patent Application Publication
(10) Pub. No.: US 2025/0203409 A1
(43) Pub. Date: Jun. 19, 2025

(54) Auto-detect, Predict and Notify Mobile Device Users of Service Impacts

(71) Applicant: DISH Wireless L.L.C., Englewood, CO (US)

(72) Inventor: Shawn Clark, Castle Rock, CO (US)

(73) Assignee: DISH Wireless L.L.C., Englewood, CO (US)

(21) Appl. No.: 18/541,246

(22) Filed: Dec. 15, 2023

(51) Int. Cl. H04W 24/04; H04W 24/08

(52) U.S. Cl. CPC H04W 24/04; H04W 24/08

(57) ABSTRACT

Devices, systems and processes for notifying a user mobile device (“UMD”) of an outage in a mobile communications network (“MCN”) are described. For one implementation, a computer server includes a processor and a data store, storing: first computer instructions instantiate an Outage Notification Monitor (“ONM”). The ONM notifies the UMD when a status change in an MCN component is detected which impacts current usage of the MCN by the UMD. The status change may be detected by one or more of a link status monitor, a hub status monitor, a node status monitor, and an UMD status monitor. Operations may include predicting a future status change in one of the MCN components; determining an impact of the future status change on the UMD; and notifying the UMD of the impact.

### TECHNICAL FIELD

The technology described herein generally relates to devices, systems, and processes for determining and notifying users of mobile service disruptions to their given user device(s), wherein the service disruptions arise due to operational disruptions at one or more elements of a mobile communications network (“MCN”). The technology described herein also generally relates to devices, systems, and processes for predicting upcoming mobile service disruptions to their given user devices.

### BACKGROUND

Users of mobile devices connected to a given mobile network commonly are not informed of “outages” that occur in the mobile network to which the user's mobile device is currently connected.

As used herein, an “outage” refers to a partial and/or full reduction from a given Quality of Service (“QoS”) provided to a given user's mobile device by a mobile system operator to a degraded QoS-which may include any decrease in an expected QoS up to and including an entire lack of connectivity by the given user's mobile device with one or more mobile networks. The given QoS may be an expected QoS, as specified in one or more contract documents executed between the user or another person or entity subscribing (or otherwise contracting) with the mobile system operator to provide a given mobile device with connectivity to one or more wireless communications services. The degraded QoS may be any QoS that is less than the expected QoS.

Instead, the user is simply impacted by the outage, with the user's mobile device often suddenly losing connectivity and/or having a reduced QoS. This often results in the impacted user becoming frustrated and disappointed in the quality of service provided by a mobile network operator and other concerns. Further, the impacted user may call, text message, email, or otherwise seek to communicate with customer relations representatives to determine why their mobile device has lost connectivity or is experiencing a reduced QoS, when connectivity and/or a given QoS will be restored, and the like.

Accordingly, devices, systems and methods for determining a scope and reach of a currently occurring outage for a mobile network, determining user's mobile devices impacted by the currently occurring outage, determining alternative mobile QoS solutions, if any, for the impacted user's mobile devices, and notifying the impacted users of the currently occurring outage are needed.

Further, users often are not notified of a “future outage” that is likely to occur, with respect to the QoS provided by a mobile network to the given user's mobile device. As used herein, a “future outage” is an outage that is not currently occurring, but is likely to occur at a “future time” and with respect to a given user's mobile device. As used herein, a “future time” refers to period occurring within a predetermined period specified by a mobile service operator. For one non-limiting example, a future time may be within a next five (5) minute period from a current time, or another period.

Accordingly, devices, systems and methods are needed for predicting a future outage to a given user's mobile device, notifying the user's mobile device of the future outage, and determining alternative future mobile QoS solutions, if any.

### SUMMARY

Various implementations are described of devices, systems, and processes for determining a scope and reach of a currently occurring outage for a mobile network, determining one or more customers impacted by the currently occurring outage, determining alternative mobile QoS solutions, if any, for the impacted customer(s), and notifying the impacted customer(s) of the currently occurring outage.

Various implementations are further described of predicting future outages, notifying the likely future impacted users of the future outage, and determining alternative future mobile QoS solutions, if any.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more non-transitory computer programs can be configured to perform particular operations or actions by virtue of including instructions that, when executed by a data processing apparatus, cause the apparatus to perform the actions.

For at least one implementation, a system may include a plurality of Mobile Communications Network (“MCN”) components including: a first network link; a first hub; and a second hub. The second hub may be coupled with the first hub via the first network link. The MCN components may further include a first node coupled to the first hub, a second node coupled to the second hub, a first User Mobile Device (“UMD1”) wirelessly coupled to the first node, and a second User Mobile Device (“UMD2”) wirelessly coupled to the second node. For at least one implementation, the UMD2 may be communicatively coupled to the UMD1 via a first communications path that further includes the second node, the second hub, the first network link, the first hub, and the first node. The MNC components may further include a Network Operations Center (“NOC”) that includes a NOC processor and a non-transient NOC data store, coupled to the NOC processor, storing first computer instructions, which when executed by the NOC processor, instantiate an Outage Notification Monitor (“ONM”) which performs ONM operations including notifying at least one of the UMD1 and the UMD2 when a change of status in one of the MCN components is detected.

For at least one implementation of the system, the change of status in one of the MCN components results in a degradation in a QoS provided by the MCN to at least one of the UMD1 and the UMD2.

For at least one implementation of the system, the non-transient NOC data store further stores second computer instructions, which when execute by the NOC processor, instantiate a Network Link Status Monitor (“NLSM”) which performs NLSM operations including monitoring link data for a link status change.

For at least one implementation of the system, the NOC components may include a data lake. The link data may be stored in the data lake. The NLSM operations may further include monitoring the data lake for the link status change and notifying, when detected, the ONM of the link status change. The ONM operations may further include one or more operations including: upon receiving a notification of the link status change, retrieving a current dependency set for the first network link; populating, based on the current dependency set, an impacted UMD data set; determining, when UMD1 is on the impacted UMD data set, a first impact of the link status change on UMD1; determining, when UMD2 is on the impacted UMD data set, a second impact of the link status change on UMD2; and notifying, as appropriate, the UMD1 of the first impact and the UMD2 of the second impact.

For at least one implementation of the system, one or more of the following may apply: the first network link includes a first network link component; the link data includes first network component link status data for the first network link component; the first network component link status data is stored in a data lake; the NLSM operations further include monitoring the first network link component status data for a change in component status and notifying, when detected, the ONM of the change in the component status; the ONM operations further include determining a respective impact of the change in component status on at least one UMD identified on an impacted UMD data set and notifying the at least one UMD identified on the impacted UMD data set of the respective impact of the change in component status.

For at least one implementation of the system, the non-transient NOC data store may further store second computer instructions, which when execute by the NOC processor, instantiate an NLSM which monitors link data for a link status change, and third computer instructions, which when executed by the NOC processor, instantiate a Hub Status Monitor (“HSM”) which monitors first hub data for a first hub status change and monitors second hub data for a second hub status change.

For at least one implementation of the system, the non-transient NOC data store may further store fourth computer instructions, which when executed by the NOC processor, instantiate a Node Status Monitor (“NSM”) which monitors first node data for a first node status change and monitors second node data for a second node status change.

For at least one implementation of the system, the non-transient NOC data store may further store fifth computer instructions, which when executed by the NOC processor, instantiate a User Mobile Device Status Monitor (“UMDSM”) which monitors UMD1 data for a UMD1 status change and monitors UMD2 data for a UMD2 status change.

For at least one implementation of the system, the NOC components include a data lake and one or more of the following may apply: the link data is stored in the data lake; the first hub data is stored in the data lake; the second hub data is stored in the data lake; the first node data is stored in the data lake; and the second node data is stored in the data lake.

For at least one implementation of the system, the NLSM, HSM, and NSM may perform operations including: respectively monitoring the data lake for a given status change; wherein the given status change is at least one of a link status change, a first hub status change, a second hub status change, a first node status change, and a second node status change; and notifying the ONM when the given status change is detected.

For at least one implementation of the system, the ONM operations may further include one or more of the following operations which may occur upon receiving a notification of the given status change: retrieving a current dependency set for at least one of the first network link, the first hub, the second hub, the first node, and the second node; populating, based on the current dependency set, an impacted UMD data set; determining, when UMD1 is on the impacted UMD data set, a first impact of the given status change on UMD1; determining, when UMD2 is on the impacted UMD data set, a second impact of the given status change on UMD2; and notifying, as appropriate, the UMD1 of the first impact and the UMD2 of the second impact.

For at least one implementation of the system, a current dependency set may identify multiple dependencies, including one or more of the following: a first dependency between the first network link and at least one of the first hub and the second hub; a second dependency between the first network link and at least one of the first node and the second node; a third dependency between the first network link and at least one of the UMD1 and the UMD2; a fourth dependency between the first hub and at least one of the first node and the second node; a fifth dependency between the second hub and at least one of the first node and the second node; a sixth dependency between the first node and at least one of the UMD1 and the UMD2; and a seventh dependency between the second node and at least one of the UMD1 and the UMD2.

For at least one implementation of the system, a current dependency may be repeatedly populated while data needs for at least one of the UMD1 and the UMD2 change.

For at least one implementation of the system, the ONM operations may further include one or more of the following operations: determining if a work-around is available to address, at least in part, at least one of the first impact and the second impact; instructing, when the work-around is available, a reconfiguration of at least one component of the plurality of MCN components; and wherein the reconfiguration alleviates, at least in part, at least one of the first impact and the second impact.

For at least one implementation of the system, the ONM operations may further include determining whether the first impact has been alleviated and notifying the UMD1 when the first impact has been alleviated.

For at least one implementation of the present disclosure, a computer server may include a NOC processor, and a non-transient NOC data store, coupled to the NOC processor. The NOC data store may store first computer instructions, which when executed by the NOC processor, instantiate an ONM which performs ONM operations including notifying a UMD when a change of status in an MCN component is detected which impacts current usage of the MCN by the UMD.

For at least one implementation of the computer server, the non-transient NOC data store may further store second computer instructions, which when executed by the NOC processor, instruct the ONM to perform outage prediction operations including predicting a future status change in one of the MCN components, determining an impact of the future status change on the UMD, and notifying the UMD of the impact of the future status change.

For at least one implementation of the computer server, the second computer instructions may further include generating a network outage model that identifies, based on historical data, multiple interdependencies between two or more data sets. The two or more data sets may include data for one or more MCN components. The operations may further include generating a UMD outage model based on an application of past path data for the UMD to the network outage model.

For at least one implementation of the computer server, the two or more data sets may include at least one of: historic signal strength data for at least one of the MCN components and the UMD, historic QoS data for at least one of the MCN components and the UMD, historic network data for the MCN, historic outage data for the MCN, and historic Geographic Information System (“GIS”) data for the UMD.

For at least one implementation of the computer server, the outage prediction operations may be further performed based on a current data set that includes at least one of current signal strength data for at least one of the MCN components and the UMD, current QoS data for at least one of the MCN components and the UMD, current outage data for the MCN, and current GIS data for the UMD.

For at least one implementation of the computer server, the MCN components may include a first link, a first hub, and a second hub. The first link may couple the first hub with the second hub. The MCN components may also include a first node coupled to the first hub, a second node coupled to the second hub, and a data lake storing data for the MCN components. The non-transient NOC data store may further store one or more of the following: second computer instructions, which when execute by the NOC processor, instantiate an NLSM which monitors the data lake for data indicative of a first link status change; third computer instructions, which when executed by the NOC processor, instantiate an HSM which monitors the data lake for data indicative of at least one of a first hub status change and second hub status change; fourth computer instructions, which when executed by the NOC processor, instantiate an NSM which monitors the data lake for data indicative of at least one of a first node status change and a second node status change; and fifth computer instructions, which when executed by the NOC processor, instantiate a MUDSM which monitors the UMD for a UMD status change.

For at least one implementation of the present disclosure a non-transitory computer readable medium, having stored thereon computer instructions which, when executed by a processor of an NOC for a MCN having two or more MCN components including at least one of an MCN link, an MCN hub, and an MCN node, may cause the NOC to perform operations including one or more of the following: instantiate a Network Link Status Monitor which detects data indicative of a status change in the MCN link; instantiate a Hub Status Monitor which detects data indicative of a status change in the MCN hub; instantiate a Node Status Monitor which detects data indicative of a status change in the MCN node; and instantiate an Outage Notification Monitor which notifies a User Mobile Device when a change of status in at least one of the two or more MCN components is detected which impacts current usage of the MCN by the UMD.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an implementation of a customer impact calculation system and in accordance with at least one implementation of the present disclosure.

FIG. 2 is a schematic illustration of several network links and hubs utilized in a mobile network, with respect to which the customer impact calculation system of FIG. 1 may be utilized, and in accordance with at least one implementation of the present disclosure.

FIG. 3 is a schematic illustration of a series of nodes utilized in a mobile network, with respect to which the customer impact calculation system of FIG. 1 may be utilized, and in accordance with at least one implementation of the present disclosure.

FIG. 4 is a schematic illustration of a network operations center configured for use in the customer impact calculation system of FIG. 1 and in accordance with at least one implementation of the present disclosure.

FIG. 5 is a schematic illustration of a user device configured for use in the customer impact calculation system of FIG. 1 and in accordance with at least one implementation of the present disclosure.

FIG. 6 is a flow chart illustrating a process for determining when a degradation has occurred to one more MCN components and automatically notifying impacted user mobile devices of the degradation, as executed by a network operations center configured for use in the customer impact calculation system of FIG. 1 and in accordance with at least one implementation of the present disclosure.

FIG. 7 is a flow chart illustrating a process for predicting a future outage in the MCN and in accordance with at least one implementation of the present disclosure.

### DETAILED DESCRIPTION

Various implementations of the present disclosure describe devices, systems, and processes for determining a scope and reach of a currently occurring outage for a mobile network, determining one or more customers impacted by the currently occurring outage, determining alternative mobile QoS solutions, if any, for the impacted customer(s), and notifying the impacted customer(s) of the currently occurring outage.

Various implementations of the present disclosure further describe devices, systems and processes for predicting future outages, notifying the likely future impacted user's mobile device of the future outage, and determining alternative future mobile QoS solutions, if any.

“Acceptable delay” is a delay of less than a given metric, for example and not by limitation, four seconds (4s) under normal system load conditions and thirty seconds (30s) under heavy system load conditions. An acceptable delay may vary based on current system load conditions.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“AI/ML” (Artificial Intelligence/Machine Learning) herein refers to the use of one or more supervised learning, unsupervised learning, and/or refinement learning processes (as executed by one or more processors which may include processors associated with one or more neural networks) to determine one or more of the following: identifying user content relationship based upon user activities vis-à-vis multiple instances of content; identifying based on the user content relationships identified, one or more user preferences (likes, dislikes and neutral) with respect to content and/or content characteristics (as described below); searching, based on the identified user preference(s), content sources, content databases, content libraries, and portions of such content for one or more content portions to present to the given user (such content may include content previously presented and content not previously presented to the given user) in a condensed content data set; and providing to a user device, for presentation to a given user, the condensed content data set. For at least one implementation, AI/ML also refers to the use of refinement learning where user feedback is received in response to prior instances of content identified for presentation to the user and analyzed to further refine a model that associates user content preferences with user content activities.

“Application” (“App.”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating AET functions. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in one or more of a cache, a memory, a data storage device, or otherwise, the given data packet has a non-transient state. For example, and not by limitation, data may take any form including as one or more applications, content, or otherwise. Instructions, as further described herein, are a form of data.

“Data store” herein refers to any non-transient device, combinations of devices, component of a device, combinations of components of one or more devices, or the like configured to store data on a temporary, permanent, non-transient, or other basis. A data store is also referred to herein as a “computer readable medium” and/or a “non-transitory computer readable medium.” A data store may store data in any form, such as electrically, magnetically, physically, optically, or otherwise. A data store may include a cache on a processor, memory devices, with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transient data, computer instructions, or other the like may be suitably stored in a data store permanently or temporarily. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store data which, while communicated may be transient or non-transient, but while stored, is defined herein to be a form of non-transient data.

“Device” and “electronic device” herein refer to any known or later arising electrical device configured to, singularly and/or in combination, communicate, manipulate, output (e.g., for presentation as information to a human), process, store, or otherwise utilize data. One non-limiting example of a device includes a User Devices.

“Instruction” herein refers to a non-transient processor executable instruction, associated data structures, sequence of operations, program modules, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Likely” as used herein means that a result has a greater than fifty percent (50%) probability of occurring.

“Module” (also referred to herein as a “Monitor”) herein refers to and, when claimed, recites definite structure for a device that is configured to provide at least one feature and/or output signals and/or perform at least one function including one or more of the features, output signals and functions described herein. A module/monitor may provide the one or more functions using computer engines, processors, computer instructions, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module/monitor. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module/monitor and the features and functions supported therein.

“Power Supply/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Security Component/Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous (ly)” herein refers to an absence of a greater than expected and humanly perceptible delay between a first event or condition and a second event or condition. Substantial simultaneity may vary in a range of quickest to slowest expected delay, to a moderate delay, or to a longer delay. For at least one implementation, substantial simultaneity occurs within an acceptable delay (as described above).

“User” herein refers to one or more of a single person, a household of people (such as those in a family), a collection of people (e.g., those in a fraternal organization or a club), or any other association of one or more human beings. A given household may have multiple users and/or collections of users (e.g., parents being one collection of users with children being a second collection of users in a household).

“User Device” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Customer Impact Calculation System 100

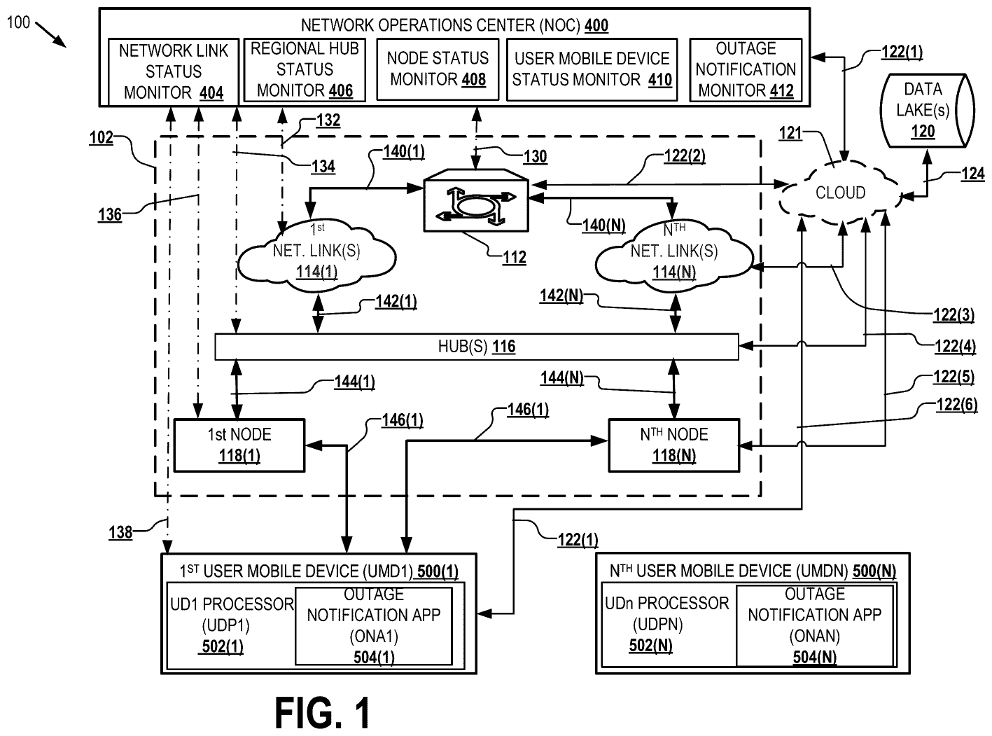

As shown in FIG. 1 and for at least one implementation of the present disclosure, a Customer Impact Calculation System (“CICS”) 100, may include an NOC 400, executing computer instructions which instantiate one or more of an NLSM 404, an HSM 404, an NSM 408, a UDSM 410, and an ONM 412. The CICS 100 may also include one or more UMDs 500, such as a first user mobile device (UMD1) 500(1) and an Nth user mobile device (UMDN) 500(N), where “N” is an integer. The UMDs 500 may be configured to execute non-transient computer instructions which instantiate an outage notification application (“ONA”) on the given UMD 500, such as a first ONA (“ONA1”) 504(1) executing on the UMD1 500(1) and an Nth ONA (“ONAN”) 504(N) executing on the UMDN 500(N).

As further shown in FIG. 1, the CICS 100 may be configured for use with at least one MCN 102. The MCN 102 may include any known and/or later arising mobile communications systems devices, systems, servers, switches, links, hubs, nodes, or the like which facilitate the providing of mobile communications services to a given UMD 500. Such mobile communications services may be provided by one or more mobile services providers, with non-limiting examples thereof including (e.g., in the United States of America) AT&T®, VERIZON®, BOOST MOBILE®, T-MOBILE®, and others.

The MCN 102 may include at least one communications server 112. The NOC 400 may be coupled to the communications server 112 by one or more first control couplings 130. For at least one implementation, the NOC 400 may be configured to control one or more operations of the one or more communications servers 112 utilized to provide mobile communications services to a given UMD 500.

The MCN 102 may further virtually include at least one network link 114, such as a first network link 114(1) and an Nth network link 114(N), which are shown in FIG. 1 for purposes of illustration and not limitation. A PHOSITA will appreciate that the network links 114 may be communicatively realized (e.g., as used to facilitate the communication of data between at least one sending location and one or more receiving locations) by one or more physical components and/or system components such as by one or more cablings (e.g., fiber optic cables, T-1 cables, or the like and associated components thereof), wireless links (e.g., microwave links, radio links, satellite links or the like and associated components thereof), or the like. Herein, those components utilized to communicatively couple, for purposes of data transmission, the network links 114 with the communications server 112 and or with one or more hubs 116 are illustrated by one or more first data couplings 140. The first network link 114(1) is further shown as being logically coupled to the NOC 400, e.g., for purposes of link monitoring, control, and the like, by a second control coupling 132. Each network link 114 may be logically coupled to the NOC 400 by one or more second control couplings 132.

The MCN 102 may further include one or more hubs 116. A hub 116 may include any known and/or future arising devices, systems, components, or the like which facilitate the communication of data between two or more nodes 118 within a given defined area, where such area may be defined logically, virtually, geographically, or otherwise. As shown in FIG. 1, the hub 116 may be coupled to the first network link 114(1) by a first-second data coupling 142(1) and to the Nth network link 114(N) by an Nth-second data coupling 142(N). The hub 116 is further shown as being logically coupled to the NOC 400, e.g., for purposes of hub monitoring, control, and the like, by a third control coupling 134.

As further shown in FIG. 1, the MCN 102 may further include one or more nodes 118, such as a first node 118(1) and an Nth node 118(N). A node 118 may include any known and/or future arising devices, systems, components, or the like which facilitate the communication of data to/from UMDs 500. A non-limiting example of a node 118 is a fifth generation (“5G”) communications tower. A given node 118 may include numerous devices, systems and components which facilitate the communication of data by and between mobile devices and other devices, systems, servers, or the like. For a non-limiting example, a node 118 may include one or more amplifiers, antenna, signal processors, or the like. A given node 118 may be coupled to a given hub 116 by a third data coupling 144. For example and as shown in FIG. 1, a first node 118(1) may be coupled to the hub 116 by a first-third data coupling 144(1) and an Nth node 118(N) may be coupled to the hub by an Nth-third data coupling 144(N). A given node 118 may be coupled to a given hub 116 at any given time and may and/or configured and capable of being coupled with one or more other hubs 116 at any given time.

A node 118 may be further coupled to one or more given UMDs 500, such as a first UMD 500(1). Such coupling may occur by one more fourth data couplings 146, such as the first-fourth data coupling 146(1) shown in FIG. 1 for purposes of illustration and not limitation. A given node 118 is further shown as being logically coupled to the NOC 400, e.g., for purposes of node monitoring, control, and the like, by a fourth control coupling 136, such as the first control coupling 136 shown in FIG. 1 for purposes of illustration and not limitation. Further, a given user mobile device, such as UMD1 500(1) may be logically coupled to the NOC 400, e.g., for purposes of UMD 500 monitoring, control, configuration, and the like, by a fifth control coupling 138. Further, in FIG. 1, couplings by and between two or more network links 114, nodes 118 and/or UMDs 500 are not shown for purposes of illustrative simplification only.

As further shown in FIG. 1, a CICS 100 may include one or more “data lakes” 120 that are logically, communicatively and respectively coupled, e.g., via the Cloud 121, to the NOC 400, the communications server(s) 112, the network links 114, the hubs 116, the nodes 118 and the UMDs 500 by one or more Cloud couplings 122. For example and not by limitation, a first cloud coupling 122(1) couples the NOC 400 with the data lake(s) 120, a second cloud coupling 122(2) couples the communications server(s) 112 with the data lake(s) 120, a third cloud coupling 122(3) couples a given network link 114 with the data lake(s) 120, a fourth cloud coupling 122(4) couples the hub 116 with the data lake(s) 120, a fifth cloud coupling 122(5) couples a given node 118 with the data lake(s) 120, and a sixth cloud coupling 122(6) couples a given UMD 500 with the data lake(s) 120.

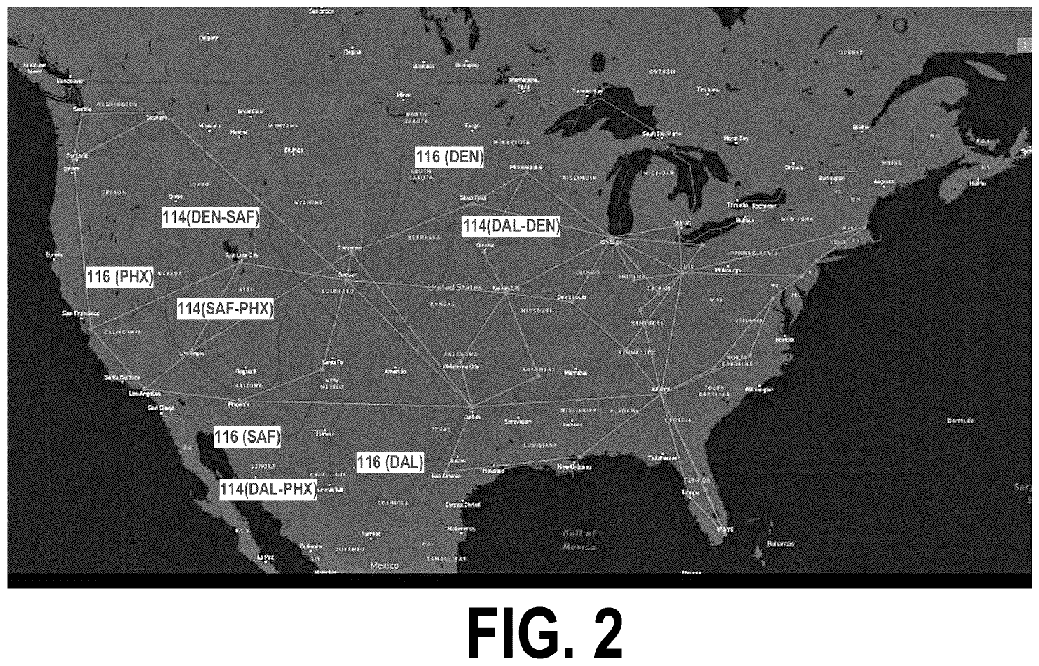

As shown in FIG. 2, an illustrative example of a MCN 102 that includes a plurality of network links 114 coupling a plurality of hubs 116 is shown. For example, a hub 116 may be located in Dallas (as indicated by the element number 116 (DAL)). Other hubs are illustrated, for purposes of explanation and not by limitation, as being located in Denver, Santa Fe, and Phoenix (as indicated by the element numbers 116 (DEN), 116 (SAF) and 116 (PHX)). One or more network links 114 may communicatively couple these (and other) hubs (as indicated by a Dallas to Phoenix network link 114(DAL-PHX), a Dallas to Denver network link 114(DAL-DEN), a Denver to Santa Fe network link 114(DEN-SAF), and a Santa Fe to Phoenix network link 114(SAF-PHX)). The network links 114 may utilize one or more first data couplings 140, second data couplings 142, first control couplings 130 and/or second control couplings 132 to communicate data by and between hubs 116 and/or with the communications server(s) 112. The MCN 102 may be configured to utilize one or more of such hubs 116 and network links 114, as needed to transport data packets between a sending device, such as the UMD1 500(1), and a receiving devices, such as the UMDN 500(N) that are communicatively coupled to one or more given hubs 116 at a given time.

For at least one implementation, the Network Link Status Monitor (NLSM) 404 may be facilitated by the NOC 400 and configured to monitor the operational status of one more, if not each, of the network links 114 utilized for the MCN 102. The Hub Status Monitor (HSM) 405 may be configured to monitor the operational status of one or more, if not each, of the hubs 116 utilized for the MCN 102.

It is to be appreciated that the operation and/or ownership and/or control of one or more of such network links 114 and/or hubs 116 may be provided by the operator of the MCN 102 itself and/or by one or more third party entities. For at least one implementation, the operational status and capabilities of a given network link 114 and/or hub 116 may be populated into the data lake 120 shown in FIG. 1. For at least one implementation, the data lake 120 maintains records for one or more, including each, of the network links 114 and hubs 116 utilized in the MCN 102. As discussed above, such network links 114 and hubs 116 may include numerous physical, logical and virtual devices, systems and components. The data lake 120 may be populated with the operational status, capabilities, configurations, data loads and other data useful in operating the MCN 102 and detecting changes in a QoS provided by the MCN 102 to a given UMD 500 that is communicatively coupled to and/or utilizing one or more given network links 114 and/or hubs 116, and the like.

For at least one implementation, a Node Status Monitor (NSM) 408 may be facilitated by the NOC 400 and configured to monitor the operational status of one more, including each, of the Nodes 118 utilized for the MCN 102. It is to be appreciated that the operation and/or ownership and/or control of one or more of the nodes 118 may be provided by the operator of the MCN 102 itself and/or by one or more third party entities. For at least one implementation, the operational status and capabilities of a given node 118 may be populated into the data lake 120. For at least one implementation, the data lake 120 maintains records for one or more, including each, of the nodes 118 utilized in the MCN 102. As discussed above, the nodes 118 may include numerous physical, logical and virtual devices, systems and components. The data lake 120 may be populated with the operational status, capabilities, configurations, data loads and other data useful in operating the MCN 102, detecting changes in a QoS provided by the MCN 102, UMDs 500 communicatively coupled to and/or utilizing one or more given node 118 and the like.

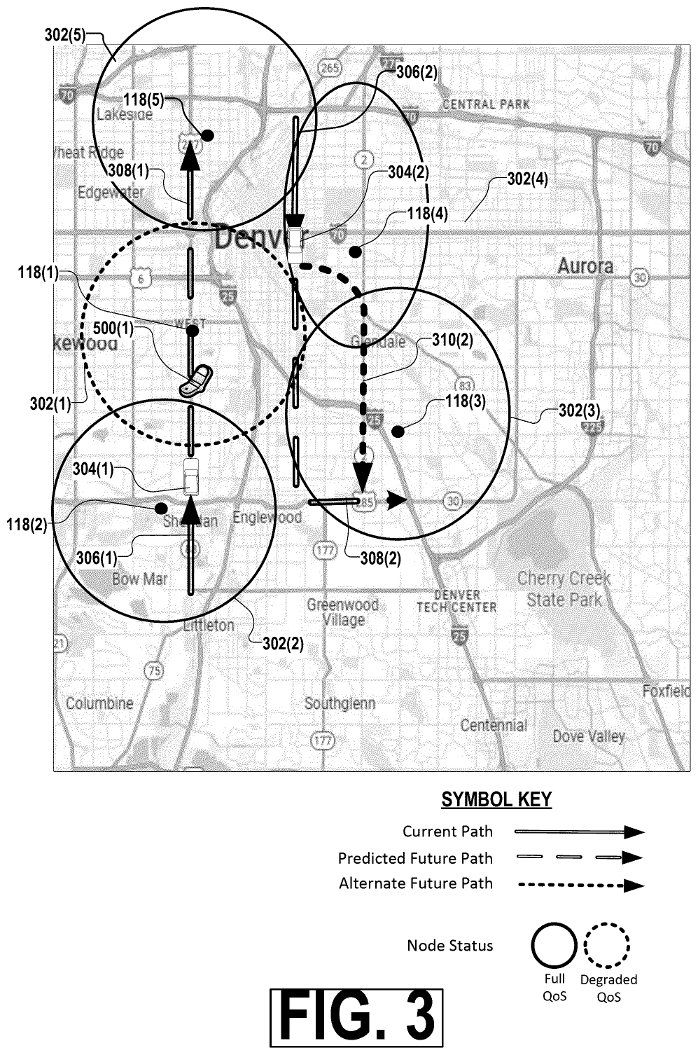

As shown in FIG. 3, a plurality of nodes 118 may be provided by a MCN 102. For example and not by limitation, a first node 118(1), a second node 118(2), a third node 118(3), a fourth node 118(4) and a fifth node 118(5) are illustrated. Each of the plurality of nodes 118 may be communicatively coupled to one or more hubs 116 (not shown). The nodes 118 may be configured to send and receive wireless (RF) communications signals within a node signal area 302. The node signal area 302 may be configured to encompass any given geographic area and may vary in signal range dimensions, frequencies utilized, signal characteristics (e.g., bandwidth, signal power, sensitivity, and modulation), and the like. Any known or later developed wireless communication technologies may be utilized by a given node 118. Two or more nodes 118 may have overlapping, in whole or in part, node signal areas 302. For example, a first node 118(1) may have a first node signal area 302(1) that overlaps in part with a second node signal area 302(2) provided by a second node 118(2). For illustrative purposes, a third node signal area 302(3), a fourth node signal area 302(4), and a fifth node signal area 302(5) are shown.

As further shown in FIG. 3, a UMD 500 may be located, at a given time, at a fixed location, as shown by UMD1 500(1), and/or positioned within a moving vehicle, such as a first vehicle 304(1) or a second vehicle 304(2). The vehicle 304 may be any form of transportation with non-limiting examples including scooters, bicycles, automobiles, trains, busses, trucks, boats, planes, drones, and the like. The UMD 500 may be within one or more node signal areas 302, at a given time. For example, the UMD1 500(1) is shown as being located within the first node signal area 302(1), the second node signal area 302(2) and the third node signal area 302(3).

It is to be appreciated that a given node 118 may be coupled with a given hub 116 that may be further coupled by one or more network links 114 with other components of a given MCN 102. A degradation in one or more of such MCN components may result in a degradation in the QoS that a given node, such as the first node 118(1) may provide, at a given time, to a given UMD such as the UMD1 500(1), as shown in FIG. 3.

More specifically and by illustrative example only, as shown by the dashed line for the first node signal area 302(1), a node 118 may experience, at a given time, a degradation in a QoS available to one or more UMDs 500. For example, the first node 118(1) may experience a degradation in a QoS that currently affects the UMD1 500(1) but does not then affect a UMD located in the first vehicle 304(1) or the UMD located in the second vehicle 304(2).

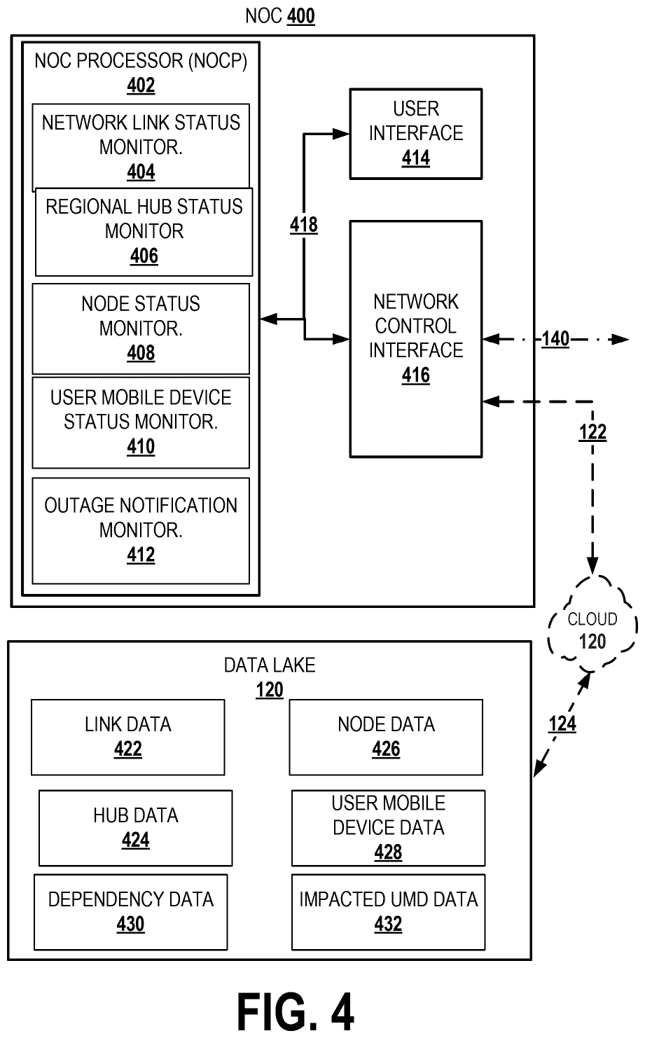

For at least one implementation, the NSM 408 and UMDSM 410 may be configured to respectively monitor the status of the nodes 118 and UMDs 500 and identify when a degradation in the QoS available by one or more nodes 118 will affect one or more UMDs 500. Again, such degradation may occur via other components of the MCN 102. The effects of such QoS degradation may impact one or more UMDs 500. To perform such monitoring, and for at least one implementation, the NOC 400 may be configured as shown in FIG. 4.

As shown in FIG. 4 and as described above, a NOC 400 may include a NOC processor (NOCP) 402 that is configured to execute non-transient computer instructions that instantiate one or more of the network link status monitor (NLSM) 404, the hub status monitor (HSM) 406, the node status monitor (NSM) 408, the user mobile device status monitor (UMDSM) 410, and the outage notification monitor (ONM) 412. The computer instructions for each of the forgoing may be stored in a data store that is coupled to the NOCP 402. Such data store may be included with the NOCP 402, provided by a networked data store, provided via the CLOUD 121, by the data lake 120, or otherwise. One or more NOCPs 402 may be utilized to instantiate the one or more monitors. The NOCPs 402 may be actualized and/or configured in any known or later arising processing actualizations and/or configurations, and the like.

As further shown in FIG. 4, the NOC 400 may include a user interface 414, a network control interface 416, and other (not shown) security modules, data stores, power modules, interfaces, and the like. A NOC bus 418 may couple the various modules, components and the like of the NOC 400. The NOC 400 may be coupled to the CLOUD 121 by a cloud coupling 122, which may be further coupled to the data lake 120 by a Cloud 121 to data lake coupling 124. The data lake 120 may be configured to store the link data 422, hub data 424, node data 426, UMD data 428, and other data. As described above, data stored in the data lake 120 may include data for any of the various devices, components, modules, or the like utilized to provide in a physical, virtual, or logical manner any of the features, functions, and/or data communications and processing capabilities, as represented by an expected QoS, to be provided by a given network link 114, hub 116, and/or node 118 to a given UMD 500, and at any given time.

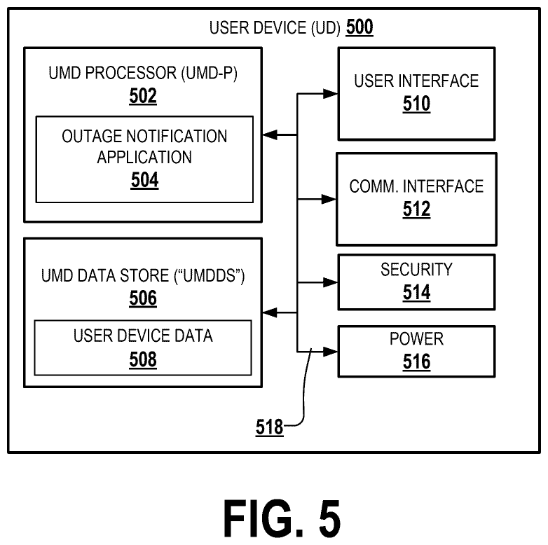

As shown in FIG. 5 and for at least one implementation, a UMD 500 may include a UMD processor (“UMDP”) 502 that is configured to execute non-transient computer instructions which, when executed, instantiate the outage notification application (ONA) 504. The UMD 500 may also include a UMD data store (“UMDDS”) 506 configured to store the user device data 508. The user device data 508 may include any data associated with a given UMD 500 and/or with a given user of the given UMD 500. Non-limiting examples of user device data 508 include user demographic data, usage rights/terms/privileges and the like which govern where/when/how and otherwise the given UMD 500 may utilized the MCN 102, user preference data, UMD location data, UMD capabilities, and other data which facilitates use by the UMD 500 of the MCN 102 for any given purpose. As further shown, the UMD 500 may include a user interface 510, a communications interface 512, a security module 514, a power module 516, a bus 518, and the like.

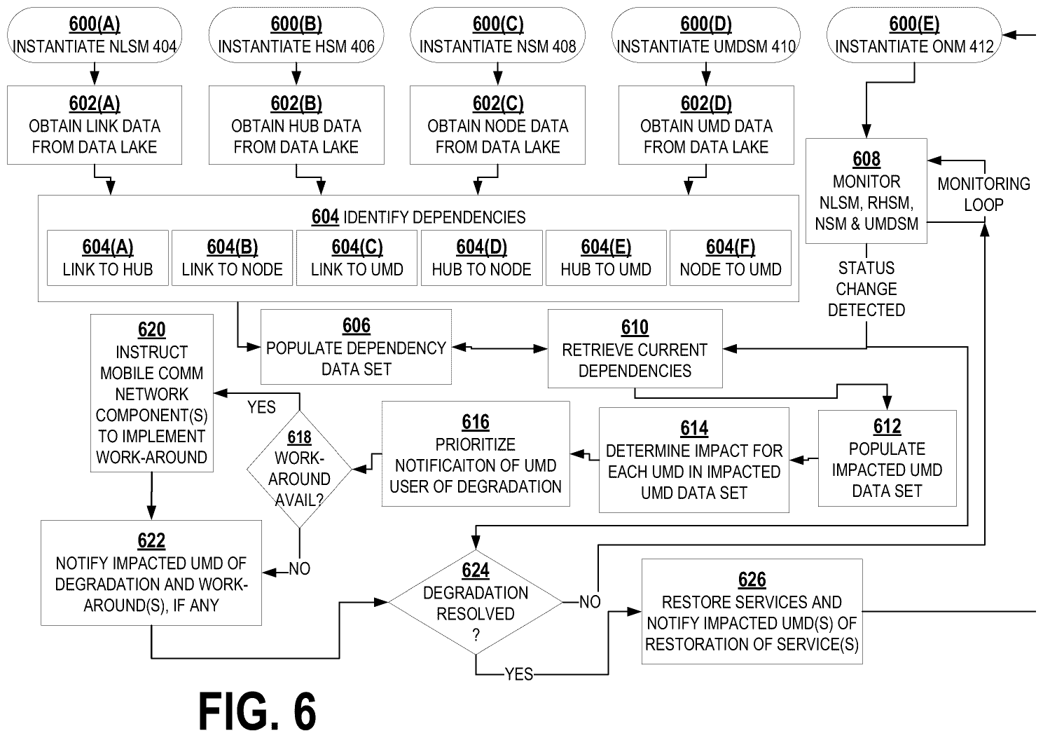

As shown in FIG. 6 and for at least one implementation of the present disclosure, a process for determining and notifying a user of a UMD of actual service disruptions may be implemented by the NOC executing the computer instructions that instantiate one or more of the NLSM 404, HSM 405, NSM 408, UMDSM 410, and the ONM 412. The implementations may also include a UMD 500 executing computer instructions that instantiate an ONA 504.

As per Operations 600(A) to 600(E), the process may include the NOCP 402 instantiating the NLSM 404, HSM 406, NSM 408, UMDSM 410, and ONM 412. These instantiations may be performed in any order, in parallel, or otherwise.

As per Operations 602(A) to 602(E), the process may include one or more of the monitors obtaining data from the data lake 120.

As per Operation 602(A), the NLSM 404 may obtain link data 422 from the data lake 120. For at least one implementation, the link data 422 may include identifications of devices, modules, computer instructions, engines, modules, monitors, assemblies and the like (individually and collectively, “link components”) that facilitate the operations of a given network link 114. The link data 422 may also include capabilities and configurations, operational status, of the like of the given network link 114 as an entity and one or more of the given link components for the given network link 114. The link data 422 may also include an identification of hub(s) coupled to the given network link 114.

It is to be appreciated that the link data 422 may be dynamically changing as network links 114 status changes and as the status of link components for a given network link 114 change. The NLSM 404 may be configured to monitor the link data 422 for changes therein on any basis including, for at least one implementation, on a continual basis. It is to be appreciated that link components for a given network link 114 may include hundreds of components, which when extrapolated across a given MCN 102 that includes hundreds of network links 114, may result in a data set for the link data 422 including millions of bytes of data, any of which may be indicative of a current and/or likely future degradation in QoS for a given network link 114. Accordingly, it is to be appreciated that the NLSM 404 may be instantiated in parallel across multiple processors that cooperatively and substantially simultaneously monitor the link data 422 populated into multiple data lakes 120.

As per Operation 602(B), the HSM 406 may obtain hub data 424 from the data lake 120. For at least one implementation, the hub data 424 may include identifications of devices, modules, assemblies, computer instructions, engines, modules, monitors, and the like (individually and collectively, “hub components”) that facilitate the operations of a hub 116. The hub data 424 may also include capabilities and configurations, operational status, of the like of the given hub 116 as an entity and one or more of the given hub components for the given hub 116. The hub data 424 may also include an identification of one or more nodes 118 coupled to the given hub 116.

It is to be appreciated that the hub data 424 may be dynamically changing as hub status' change and as the status of hub components for a given hub 116 change. The HSM 406 may be configured to monitor the hub data 424 for changes therein on any basis including, for at least one implementation, on a continual basis. It is to be appreciated that hub components for a given hub 116 may include hundreds of components, which when extrapolated across a given MCN 102 that includes thousands of hubs 116, may result in a data set for the hub data 424 including billions of bytes of data, any of which may be indicative of a current and/or likely future degradation in QoS for a given hub 116. Accordingly, it is to be appreciated that the HSM 406 may be instantiated in parallel across multiple processors that cooperatively and substantially simultaneously monitor the hub data 424 populated into multiple data lakes 120.

As per Operation 602(C), the NSM 408 may obtain node data 426 from the data lake 120. For at least one implementation, the node data 426 may include identifications of devices, modules, assemblies, computer instructions, engines, modules, monitors, and the like (individually and collectively, “node components”) that facilitate the operations of a node 118. The node data 426 may also include capabilities and configurations, operational status, of the like of the given node 118 as an entity and one or more of the given node components for the given node 118. The node data 426 may also include an identification of one or more UMDs 500 coupled to the given node 118.

It is to be appreciated that the node data 426 may be dynamically changing as a multiple nodes status' change and as the status of node components for a given node 118 change. The NSM 408 may be configured to monitor the node data 426 for changes therein on any basis including, for at least one implementation, on a continual basis. It is to be appreciated that node components for a given node 118 may include hundreds of components, which when extrapolated across a given MCN 102 that includes millions of nodes 118, may result in a data set for the node data 426 including terabytes of data, any of which may be indicative of a current and/or likely future degradation in QoS for a given node 118. Accordingly, it is to be appreciated that the NSM 408 may be instantiated in parallel across multiple processors that cooperatively and substantially simultaneously monitor the node data 426 populated into multiple data lakes 120.

As per Operation 602(D), the UMDSM 410 may obtain UMD data 428 from the data lake 120. For at least one implementation, the UMD data 428 may include identifications of devices, modules, assemblies, computer instructions, engines, modules, monitors, and the like (individually and collectively, “UMD components”) that facilitate the operations of a UMD 500. The UMD data 428 may also include capabilities and configurations, operational status, of the like of the given UMD 500 as an entity and one or more of the given UMD components for the given UMD 500. The UMD data 428 may also include an identification of one or more user currently utilizing the given UMD 500.

It is to be appreciated that the UMD data 428 may be dynamically changing as multiple UMDs status' change and as the status of UMD components for a given UMD 500 change. The UMDSM 410 may be configured to monitor the UMD data 428 for changes therein on any basis including, for at least one implementation, on a continual basis. It is to be appreciated that UMD components for a given UMD 500 may include hundreds of components, which when extrapolated across a given MCN 102 that includes tens of millions of UMDs 500, may result in a data set for the UMD data 428 including petabytes of data, any of which may be indicative of a current and/or likely future degradation in QoS for a given UMD 500. Accordingly, it is to be appreciated that the UMDSM 410 may be instantiated in parallel across multiple processors that cooperatively and substantially simultaneously monitor the UMD data 428 populated into multiple data lakes 120.

As per Operations 604(A) to 604(F), the process may include the ONM 412 identifying dependencies across the various components of the MCN 102. As used herein, a “dependency” is an association of a first component of the MCN 102, such as a given network link 114, with a second component of the MCN 102, such as a given hub 116 and for the purpose of communicating data between at least one sender and at least one recipient. A dependency may occur physically, virtually, a combination of the foregoing, or otherwise. A dependency may occur at any given time and for any given period, including a transient dependency that may occur on an as needed basis to facilitate communication of data packets having certain characteristics, such as requiring a certain maximum latency, a bandwidth, or otherwise.

As per Operation 604(A), the process may include identifying one or more dependencies between a given network link 114 and a given hub 116. The identification of any such one or more dependencies may be made based upon a substantially real-time analysis of the link data 422 and the hub data 424 respectively obtained per Operations 602(A) and 602(B).

As per Operation 604(B), the process may include identifying one or more dependencies between a given network link 114 and a given node 118. The identification of any such one or more dependencies may be made based upon a substantially real-time analysis of the link data 422 and the node data 426 respectively obtained per Operations 602(A) and 602(C).

As per Operation 604(C), the process may include identifying one or more dependencies between a given network link 114 and a given UMD 500. The identification of any such one or more dependencies may be made based upon a substantially real-time analysis of the link data 422 and the UMD data 428 respectively obtained per Operations 602(A) and 602(D).

As per Operation 604(D), the process may include identifying one or more dependencies between a given hub 116 and a given node 118. The identification of any such one or more dependencies may be made based upon a substantially real-time analysis of the hub data 424 and the node data 426 respectively obtained per Operations 602(B) and 602(C).

As per Operation 604(E), the process may include identifying one or more dependencies between a given hub 116 and a given UMD 500. The identification of any such one or more dependencies may be made based upon a substantially real-time analysis of the hub data 424 and the UMD data 428 respectively obtained per Operations 602(B) and 602(D).

As per Operation 604(F), the process may include identifying one or more dependencies between a node 118 and a given UMD 500. The identification of any such one or more dependencies may be made based upon a substantially real-time analysis of the node data 426 and the UMD data 428 respectively obtained per Operations 602(C) and 602(D).

As per Operation 606, the process may include utilizing the results obtained from Operations 604(A) to 604(F) to populate one or more of the dependency data set(s) 430. For at least one implementation, one or more of the dependency data set(s) 430 may be expressed in a logical structure, such as in a matrix, a relational database, a hierarchical relationship, or otherwise that identifies and may be utilized to determine dependencies between various MCN components and UMDs 500. The dependency data sets 430 facilitate identification of a MCN component experiencing a QoS degradation, or other degradation in one or more capabilities of the MCN component. The dependency data sets 430 further facilitate identification of UMDs 500 affected by such degradation so that the effected UMDs 500 may be substantially simultaneously notified, of the occurrence of the degradation.

It is to be appreciated that due to the mobile nature of the MCN 102, the dependencies between a given MCN 102 component and a UMD 500 may be substantially continually changing. For example, the UMD 500 may move through a geographic area and (dis) establish connections with different nodes 118. Likewise, the UMD 500 may have communications needs that change based upon a location of a given sender or recipient of a given data packet. For example, a UMD 500 seeking to stream a given video may need to establish a communications link with a server or other device using one or more direct or indirect couplings by and between one more of a nodes 118, hubs 116 and/or network links 114 that are other than nodes 118, hubs 116 and/or network links 114 that the given UMD 500 is currently coupled to/with. Further, a given UMD 500 may have multiple substantially simultaneously couplings with nodes 118 and/or other wireless communications network components at any given time. Such couplings may have different communications needs and/or data transport requirements; some of which may be varying on a continual or other basis. Accordingly, the dependency data set(s) 430 may be considered, for at least one implementation, to be dynamic data set(s).

As per Operation 608, the process may include the ONM 412 monitoring one or more, including each, of the NLSM 404, HSM 406, NSM 408, and UMDSM 410 for changes in a status of MCN component. A monitoring loop may be performed until a change of status is detected. For at least one implementation, the monitoring loop may be performed every one hundred microseconds (100 μsec). When a change in status of a MCN component is detected, the process proceeds to Operation 610.

As per Operation 610, the process may include retrieving one or more of the dependencies, from the dependency data set populated per Operation 606, implicated by the detected change of status.

As per Operation 612, the process may include populating an impacted UMD data set 432. The impacted UMD data set 432 identifies the one or more UMDs 500 impacted by a degradation of a given MCN component. As shown in FIG. 4, the impacted UMD data set 432 may be stored in the data lake 120. For example and not by limitation, a change of status detected for a given node 118 may result in a retrieval, from the dependency data set 430, of a list of UMDs 500 that are/were coupled to the given node 118 when the degradation was detected. Such list of UMDs 500 may be used to populate the impacted UMD data set 432, wherein the impacted UMD data set identifies the one or more UMDs 500 that were/are coupled to the given node 118, at substantially the given time that the change of status was detected for the given node 118.

As per Operation 614, the process may include determining an impact, due to the status change, for each of one or more of the UMDs 500 identified in the impacted UMD data set. It is to be determined that a degradation of a given MCN may have different impacts upon different UMDs 500. For example, a degradation identified as affecting a UMD 500 associated with an emergency responder will generally have a more significant impact than a degradation identified as affecting an online gamer's use of a given UMD 500. The impact of a status change of a given MCN component may vary based on any number of factors including, but not limited to, UMD user, type of data/communications needs, nature of the impact, and otherwise. For at least one implementation, the process may include determining a gravity or weighting of the impact of a given status change with such determining using, at least in part, one or more predetermined and/or substantially real-time determined impact thresholds.

As per Operation 616, the process may include prioritizing notification of UMD(s) 500 of the degradation based upon the impact determined per Operation 614.

As per Operation 618, the process may include determining if a work-around is available that can minimize and/or eliminate one or more impacts (if not all impacts), from the degradation to the MCN component, on the given impacted UMD(s) 500. If a work-around is available, the process may include Operation 620. Otherwise, the process proceeds to Operation 622. For example and as shown in FIG. 3, a work-around for a UMD 500 associated with the second vehicle 304(2) when the first node 118(1) suffers a degradation may include routing the second vehicle 304(2) down an alternative path 310 (2)—the alternative path 310(2) including the third node signal area 302(3), and fourth node signal area 302(4) that are not impacted by the degradation to the first node signal area 302(1).

As per Operation 620, the process may include instructing one or more MCN component to implement the work-around(s) for one or more of the given impacted UMD(s). The work-around may include any utilization of one or more MCN components, wherein such utilization is instructed by the ONM 412 in response to the detected degradation of a MCN component. For a non-limiting example, a work-around for an impacted UMD due to a node degradation may include instructing another node 118 to establish a coupling with the impacted UMD, for example, by providing access to a bandwidth, frequency plan, frequency slice, or the like facilitated by another node that can alleviate some, if not all, of the impact on the impacted UMD due to the node degradation.

As per Operation 622, the process may include notifying the impacted UMD of the degradation and work-around, if any. The notifying of the impacted UMD may occur using any communicative coupling between the impacted UMD, another UMD associated with a user of the impacted UMD, another UMD geographically proximate to the impacted UMD or otherwise. The notifying may occur using components of the MCN component and/or another communications network.

As per Operation 624, the process may include determining if the degradation has been resolved. If “no,” the process may continue with Operation 608 and monitoring the MCN 102 for any other degradations. If “yes”, the process may proceed to Operation 626.

As per Operation 626, the process may include restoring MCN services impacted by the degradation to the impacted UMD(s) and notifying the impacted UMD(s) of the restoration of the MCN services. The process may then resume with Operations 600(A) to 600(E) with it being understood that the monitoring operations may be configured to run continuously and indefinitely until and/or unless the MCN experiences a down-time or the like during one or more periods.

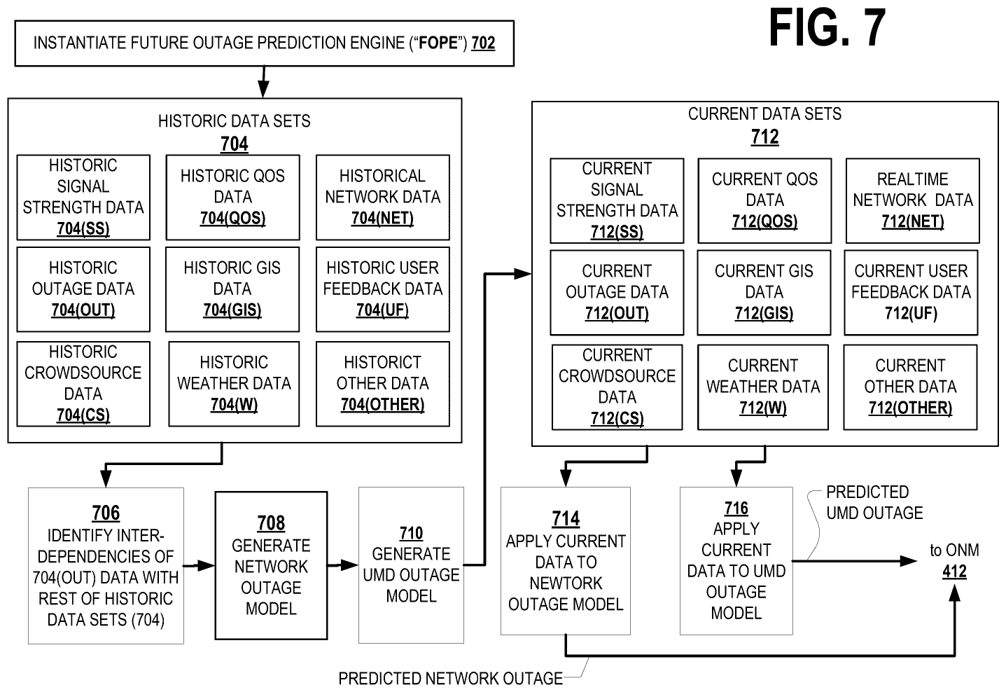

FIG. 7 illustrates a process by which a CICS 100 may be configured to predict one or more future outages in one or more components of the MCN 102 that may affect a given UMD 500 and for at least one implementation of the present disclosure.

As per Operation 702, the process may include execution, by the NOCP 402, of non-transient computer instructions which instantiate a future outage prediction engine (“FOPE”) 702. For at least one implementation, the FOPE 702 is configured to perform AI/ML operations which predict, based on a network outage model and as further based on a UMD outage model whether a given UMD 500 may experience an outage within a given period.

The FOPE 702 may be configured to execute one or more AI/ML operations to generate the network outage model. For at least one implementation, the network outage model may be generated based on inter-dependencies identified between historic outages and one or more other historic data sets. The network outage model may be utilized to predict an outage for at least one component of the MCN 102,such as one or more network links 114, hubs 116, and/or nodes 118.

For at least one implementation, the FOPE 702 may be further configured to generate a UMD outage model. The UMD outage model may be based on the network outage model as further interpreted in view of one or more of the historic data sets applicable to one or more UMDs 500. For example, the UMD outage model may be used to predict an outage by a given UMD 500 that have, at a given relevant time, one or more characteristics (e.g., a device type, a device location, or the like) and/or a need for one or more mobile communications services (e.g., a given QOS need). The generation of the network outage model and the UMD outage model are further described below with reference to Operations 704-710.

The FOPE 702 may be further configured to apply one or more current data sets to the network outage model to identify a predicted network outage for at least one component of the MCN 102. The FOPE 702 may be further configured to apply one or more current data sets to the UMD outage model, as interpreted in view of the predicted network outage, to generate a predicted UMD outage for at least one UMD 500 coupled, at a given time, to the MCN 102. The generation of the predicted network outage and the predicted UMD outage are further described below with reference to Operations 712-716. A predicted UMD outage may be provided by the FOPE 702 to the ONM 412 which may suitably notify one or more likely impacted UMDs of the predicted outage.

As per Operation 704, the process may include the FOPE 702 obtaining one or more historic data sets 704 from the data lake 120 or other data store. The historic data sets 704 may include any data that may be utilized by the AI processes to generate the network outage model and/or the UMD outage model. Non-limiting examples of the historic data sets 704 include historic signal strength data 704(SS), historic QOS data 704(QOS), historic network data 704(NET), historic outage data 704(OUT), historic Geographic Information System (“GIS”) data 704(GIS), historic user feedback data 704(UF), historic crowdsource data 704(CS), historic weather data 704(W), and historic other data 704(OTHER).

For at least one implementation, historic signal strength data 704(SS) and/or historic QOS data 704(QOS) may include data generated based on monitoring of one or more MCN components by the NLSM 404, HSM 406, NSM 408, and/or UMDSM 410. For a non-limiting example, a historically received signal strength by a UMD 500 as it enters, is in, and/or exits a given node signal area 302 may be monitored by one or more of the UMDSM 410 and/or a NSM 408. Such historic data when interpreted in view of historic outage data 704(OUT) may be used to identify an indicator (e.g., signal strength) of a potential outage.

For at least one implementation, the historic network data 704(NET) may include data identifying historical operational status of the network, as delegated in its entirety and/or a portion thereof. For example, a region (e.g., a state) in a country-wide MCN may be monitored and operational status thereof collected.

For at least one implementation, the history outage data 704(OUT) may include outage data for one component and/or multiple components of the MCN. For example, historical outage data for a node 118, hub 116, and/or network link 114 may be collected in the data lake 120. If a given component has a history of outages, as indicated by one or more trend lines and/or other statistical results that are determinable over a historic outage data set having at least fifty (50) values, an outage trend may be identified by the FOPE 702 and one or more variations, readings or the like in other MCN components' parameters, occurring with such outages, may be identified as potential causes-in-fact and/or probable causes of future outages.

For at least one implementation, historic GIS data 704(GIS) may be utilized by the FOPE 702. The historic GIS data 704(GIS) may include a mapping of one or more MCN components to a given geographic location and/or area. For example, a node 118 may be mapped, using GIS data, as providing services over a given geographic area at one or more times and/or periods.

For at least one implementation, historic user feedback data 704(UF) may be utilized by the FOPE 702. The historic user feedback data 704(UF) may include past reports of one or more degradations a given UMD 500 has experienced. Such data may include UMD device type, UMD location data, time of the degradation, a description of the degradation, and the like.

For at least one implementation, historic crowdsource data 704(CS) may be utilized by the FOPE 702. The historic crowdsource data 704(CSF) may include past reports of one or more degradations that multiple UMDs 500 have experienced. For at least one implementation, crowdsource data occurs when ten (10) or more of the UMDs 500 experienced a degradation within a given period (e.g., thirty (30) seconds) and within a given locale (e.g., a geographic area within a node signal area 302 for a given node 118.

For at least one implementation, historic weather data 704(W) may be utilized by the FOPE 702. The historic weather data 704(W) may include terrestrial and/or stellar weather reports. The historic weather data 704(W) may include one or more GIS indicators. The historic weather data 704(W) may be provided by any source, with a non-limiting example including the United States National Weather Service.

For at least one implementation, historic other data 704(OTHER) may be utilized by the FOPE 702. The historic other data 704(OTHER) may include any data from any source. Non-limiting examples of historic other data 704(OTHER) include data from emergency responder systems, earthquake sensors, power distribution systems and the like.

As per Operation 706, the process may include the FOPE 702 identifying one or more inter-dependencies between a given historic outage data 704(OUT) and one of the other historic data sets 704. The generation of the interdependencies may include generation of indices that indicate relationships between outage and data in one or more of the other historic data sets. These indices may be further processed into one more matrix structures that associate the indices across each other to provide a multi-dimensional representation of inter-dependencies between outages and multiple data sets. For example, a historic outage may be associated in a first indices as having a relationship with a power outage, as provided by historic other data 704(OTHER). The historic outage may be further associated in a second indices as having a relationship with a weather event (e.g., a high wind event), as provided by historic weather data 704(W). A third indices may associate the weather event with the power outage event. The FOPE 702 may further identify that multiples of the first indices, second indices, and third indices have each occurred over time and based on such multiples (for example at least one-hundred) that a first probability exists that when a weather event occurs a power outage may also occur and per a second probability the power outage may result in an outage of at least one MCN component. Accordingly, the first indices, second indices, and third indices may be combined to provide a network outage model matrices (of which there may be any number) that predicts network outages based on other factors, such as weather, power outages, and the like.

Further, an outage in one MCN component, such as a hub 116, may have historically effected other components, such as nodes 118 and/or network links 114 and each of such outage may be modeled, by the FOPE 702, into multiple network outage model matrices.

As per Operation 708, the FOPE 702 may be further configured to extrapolate the multiple network outage model matrices to generate an encompassing, overall network outage model. For at least one implementation, at least one-model is used for each MCN component times each type of historic data set 704 utilized by the FOPE 702.

As Operation 710, the FOPE 702 may be configured to generate a past path for a given UMD (or vehicle) based on historical path data. The past path may be generated by the FOPE 702 using historical user routing data, user calendar data, user preference data, and the like. Using the past path, as applied to the network outage model, the FOPE 702 may generate a UMD outage model that can be utilized to predict when a given UMD will, in the future, be impacted by a predicted future outage, as determined using the network outage model.

As per Operation 712, the process may include the FOPE 702 obtaining one or more current data sets 712. The current data sets 712 may correspond to the historic data sets 704 and/or may include more or less data sets. The current data sets 712 may be obtained from the data lake 120 or other data store.

For at least one implementation, ton-limiting examples of such current data sets 706 include current signal strength data 706 (SS), current QOS data 706 (QOS), current network data 706 (NET), current outage data 706 (OUT), current GIS data 706 (GIS), current user feedback data 706 (UF), current crowdsourced data 706(CS), current weather data 706(W), and current other data 706 (OTHER). The current data sets 706 may correspond to the historic data sets 704 (as described above). For at least one implementation, data is “current” when it is stored in the data lake 120 within a given period of time from an occurrence of an event that resulted in a generation of the data. It is to be appreciated that the type of data will dictate whether it is current or not. For example, weather data may be current when stored hourly on a national level and within two (2) minutes when stored on a county, or neighborhood basis. Accordingly, for at least one implementation, stored data is considered to be “current” when stored within a period that a PHOSITA would consider relevant for storage of the given data type.

As per Operation 714, the process may include the FOPE 702 applying the one or more current data sets 712 to the network outage model, as generated per Operation 708, to generate a predicted network outage. For at least one implementation, the predicted network outage may identify one or components of the MCN 102 that are likely to have an outage. The predicted network outage may further identify a severity of the predicted outage-such severity may be expressed in any terms or conditions including, but not limited to, in terms of one or more QOS degradations. The predicted network outage may further identify one or more node signal areas 302 and/or other geographic areas within which the predicted outage may occur. The FOPE 702 may output the predicted network outage to the ONM 412 for further notification processing, identification of work-arounds, implantation of work-arounds, and/or other processing.

As per Operation 716, the process may include the FOPE 702 applying the one or more current data sets 712 to the UMD outage model, as generated per Operation 710, the generate one or more predicted UMD outage(s). For at least one implementation, the predicted UMD outage(s) may identify one or UMDs then coupled to and/or likely to be substantially currently coupled to the MCN 102 that are likely to have an outage. The predicted UMD outages may further identify a severity of the predicted outage-such severity may be expressed in any terms or conditions including, but not limited to, in terms of one or more QOS degradations. The predicted UMD outage(s) may further identify one or more node signal areas 302 and/or other geographic areas within which the predicted UMD outage may occur. The FOPE 702 may output the predicted network outage to the ONM 412 for further notification processing, identification of work-arounds, implantation of work-arounds, and/or other processing.

For a non-limiting example, and as shown in FIG. 3, a predicted future path 308 for a given UMD (or vehicle) may be generated based on historical path data. The predicted future path 308 may be generated by the FOPE 702 using historical user routing data, user calendar data, user preference data, and the like. Using a predicted future path 308, the NOC 400 may be configured, for at least one implementation, to provide notifications of potential future degradations to a given UMD's MCN services based on one or more currently occurring degradations to a MCN component that the given UMD is not currently utilizing, based on a network outage model and/or based on a UMD outage model. For example, the first vehicle 304(1) is depicted as not currently being within the first node signal area 302(1), with the first node 118(1) then experiencing a QoS degradation. The CICS 100 may be configured to notify a UMD associated with the first vehicle 304(1) of the degradation and provide work-arounds, if any, that may minimize and/or eliminate impacts of the degradation on the UMD associated with the first vehicle 304(1) before the first vehicle 304(1) enter the first node signal area 302(1).

For at least one implementation, the predicted network outage and/or predicted UMD outage(s) may be used by the AI/ML processes executed by the FOPE 702 to determine when the network outage model and/or UMD outage model used to generate the respective predictions was or was not accurate and to further refine the respective models. Using such feedback, a machine learning process may be utilized by which the models are further refined (i.e., obtain greater accuracy) over time and with use thereof.

It is also to be appreciated that the operations of FIG. 7 may be configured to run continuously and indefinitely until and/or unless the MCN experiences a down-time or the like during one or more periods.

It is to be appreciated that the Operations depicted in FIGS. 6 and 7 may occur in sequence as shown, and/or in any other sequence of operations including one more operations occurring in parallel.

For at least one implementation of the present disclosure, the notification features and functions of a CICS 100 may be utilized integrated with Application Program Interfaces (APIs) provided with network providers (e.g., AT&T, T-MOBILE, VERIZON, DISH and others), UMDs 500, or otherwise. Such integrations may include those with existing communications and messaging systems such as e-mail, SMS messaging, emergency broadcast alert systems, and the like.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A system comprising:
a plurality of Mobile Communications Network (“MCN”) components including:
a first network link;
a first hub;
a second hub;
wherein the second hub is coupled with the first hub via the first network link;
a first node;
wherein the first node is coupled to the first hub;
a second node;
wherein the second node is coupled to the second hub;
a first User Mobile Device (“UMD1”);
wherein the UMD1 is wirelessly coupled to the first node;
a second User Mobile Device (“UMD2”);
wherein the UMD2 is wirelessly coupled to the second node;
wherein the UMD2 is communicatively coupled to the UMD1 via a first communications path that further includes the second node, the second hub, the first network link, the first hub, and the first node; and
a Network Operations Center (“NOC”) comprising:
a NOC processor;
a non-transient NOC data store, coupled to the NOC processor, storing:
first computer instructions, which when executed by the NOC processor, instantiate an Outage Notification Monitor (“ONM”) which performs ONM operations including:
notifying at least one of the UMD1 and the UMD2 when a change of status in one of the MCN components is detected.

2. The system of claim 1,
wherein the change of status in one of the MCN components results in a degradation in a Quality of Service (“QoS”) provided by the MCN to at least one of the UMD1 and the UMD2.

3. The system of claim 1,
wherein the non-transient NOC data store further stores:
second computer instructions, which when execute by the NOC processor, instantiate a Network Link Status Monitor (“NLSM”) which performs NLSM operations including:
monitoring link data for a link status change.

4. The system of claim 3, further comprising:
a data lake;
wherein the link data is stored in the data lake;
wherein the NLSM operations further include:
monitoring the data lake for the link status change; and
notifying, when detected, the ONM of the link status change;
wherein, the ONM operations further include:
upon receiving a notification of the link status change:
retrieving a current dependency set for the first network link;
populating, based on the current dependency set, an impacted UMD data set;
determining, when UMD1 is on the impacted UMD data set, a first impact of the link status change on UMD1;
determining, when UMD2 is on the impacted UMD data set, a second impact of the link status change on UMD2; and
notifying, as appropriate, the UMD1 of the first impact and the UMD2 of the second impact.

5. The system of claim 3,
wherein the first network link includes a first network link component;
wherein the link data includes first network component link status data for the first network link component;
wherein the first network component link status data is stored in a data lake;
wherein the NLSM operations further include:
monitoring the first network link component status data for a change in component status; and
notifying, when detected, the ONM of the change in the component status;
wherein, the ONM operations further include:
determining a respective impact of the change in component status on at least one UMD identified on an impacted UMD data set; and
notifying the at least one UMD identified on the impacted UMD data set of the respective impact of the change in component status.

6. The system of claim 1,
wherein the non-transient NOC data store further stores:
second computer instructions, which when executed by the NOC processor, instantiate a Network Link Status Monitor (“NLSM”) which monitors link data for a link status change;
third computer instructions, which when executed by the NOC processor, instantiate a Hub Status Monitor (“HSM”) which monitors first hub data for a first hub status change and monitors second hub data for a second hub status change.

7. The system of claim 6,
wherein the non-transient NOC data store further stores:
fourth computer instructions, which when executed by the NOC processor, instantiate a Node Status Monitor (“NSM”) which monitors first node data for a first node status change and monitors second node data for a second node status change.

8. The system of claim 7,
wherein the non-transient NOC data store further stores:
fifth computer instructions, which when executed by the NOC processor, instantiate a User Mobile Device Status Monitor (“UMDSM”) which monitors UMD1 data for a UMD1 status change and monitors UMD2 data for a UMD2 status change.

9. The system of claim 8,
a data lake;
wherein the link data is stored in the data lake;
wherein the first hub data is stored in the data lake;
wherein the second hub data is stored in the data lake;
wherein the first node data is stored in the data lake;
wherein the second node data is stored in the data lake;
wherein the NLSM, HSM, and NSM perform operations including:
respectively monitoring the data lake for a given status change;
wherein the given status change is at least one of a link status change, a first hub status change, a second hub status change, a first node status change, and a second node status change; and
notifying the ONM when the given status change is detected;
wherein, the ONM operations further include:
upon receiving a notification of the given status change:
retrieving a current dependency set for at least one of the first network link, the first hub, the second hub, the first node, and the second node;
populating, based on the current dependency set, an impacted UMD data set;
determining, when UMD1 is on the impacted UMD data set, a first impact of the given status change on UMD1;
determining, when UMD2 is on the impacted UMD data set, a second impact of the given status change on UMD2; and
notifying, as appropriate, the UMD1 of the first impact and the UMD2 of the second impact.

10. The system of claim 9,
wherein the current dependency set identifies multiple dependencies, including:
a first dependency between the first network link and at least one of the first hub and the second hub;
a second dependency between the first network link and at least one of the first node and the second node;
a third dependency between the first network link and at least one of the UMD1 and the UMD2;
a fourth dependency between the first hub and at least one of the first node and the second node;
a fifth dependency between the second hub and at least one of the first node and the second node;
a sixth dependency between the first node and at least one of the UMD1 and the UMD2; and
a seventh dependency between the second node and at least one of the UMD1 and the UMD2.

11. The system of claim 10,
wherein the current dependency is repeatedly populated while data needs for at least one of the UMD1 and the UMD2 change.

12. The system of claim 9,
wherein, the ONM operations further include:
determining if a work-around is available to address, at least in part, at least one of the first impact and the second impact;
instructing, when the work-around is available, a reconfiguration of at least one component of the plurality of MCN components; and
wherein the reconfiguration alleviates, at least in part, at least one of the first impact and the second impact.

13. The system of claim 9,
wherein, the ONM operations further include:
determining whether the first impact has been alleviated; and
notifying the UMD1 when the first impact has been alleviated.

14. A computer server comprising:
a Network Operations Center (“NOC”) processor; and
a non-transient NOC data store, coupled to the NOC processor, storing:
first computer instructions, which when executed by the NOC processor, instantiate an Outage Notification Monitor (“ONM”) which performs ONM operations including:
notifying a User Mobile Device (“UMD”) when a change of status in a Mobile Communications Network (“MCN”) component is detected which impacts current usage of the MCN by the UMD.

15. The computer server of claim 14,
wherein the non-transient NOC data store further stores:
second computer instructions, which when executed by the NOC processor, instruct the ONM to perform outage prediction operations including:
predicting a future status change in one of the MCN components;
determining an impact of the future status change on the UMD; and
notifying the UMD of the impact of the future status change.

16. The computer server of claim 15,
wherein the second computer instructions further include:
generating a network outage model that identifies, based on historical data, multiple interdependencies between two or more data sets;
wherein the two or more data sets include data for one or more MCN components; and
generating a UMD outage model based on an application of past path data for the UMD to the network outage model.

17. The computer server of claim 16,
wherein the two or more data sets include at least one of:
historic signal strength data for at least one of the MCN components and the UMD;
historic Quality of Service (“QoS”) data for at least one of the MCN components and the UMD;
historic network data for the MCN;
historic outage data for the MCN; and
historic Geographic Information System (“GIS”) data for the UMD.

18. The computer server of claim 15,
wherein the outage prediction operations are further performed based on a current data set that includes at least one of:
current signal strength data for at least one of the MCN components and the UMD;
current QoS data for at least one of the MCN components and the UMD;
current outage data for the MCN; and
current GIS data for the UMD.

19. The computer server of claim 18,
wherein the MCN components include:
a first link;
a first hub;
a second hub;
wherein the first link couples the first hub with the second hub;
a first node coupled to the first hub;
a second node coupled to the second hub; and
a data lake storing data for the MCN components;
wherein the non-transient NOC data store further stores:
second computer instructions, which when execute by the NOC processor, instantiate a Network Link Status Monitor (“NLSM”) which monitors the data lake for data indicative of a first link status change;
third computer instructions, which when executed by the NOC processor, instantiate a Hub Status Monitor (“HSM”) which monitors the data lake for data indicative of at least one of a first hub status change and second hub status change;
fourth computer instructions, which when executed by the NOC processor, instantiate a Node Status Monitor (“NSM”) which monitors the data lake for data indicative of at least one of a first node status change and a second node status change; and
fifth computer instructions, which when executed by the NOC processor, instantiate a MUDSM which monitors the UMD for a UMD status change.

20. A non-transitory computer readable medium, having stored thereon computer instructions which, when executed by a processor of a Network Operations Center (“NOC”) for a Mobile Communications Network (“MCN”) having two or more MCN components including at least one of an MCN link, an MCN hub, and an MCN node, cause the NOC to perform operations comprising:
instantiate a Network Link Status Monitor which detects data indicative of a status change in the MCN link;
instantiate a Hub Status Monitor which detects data indicative of a status change in the MCN hub;
instantiate a Node Status Monitor which detects data indicative of a status change in the MCN node;
instantiate an Outage Notification Monitor (“ONM”) which notifies a User Mobile Device (“UMD”) when a change of status in at least one of the two or more MCN components is detected which impacts current usage of the MCN by the UMD.
